(19) United States
(12) Patent Application Publication
(10) Pub. No.: US 2018/0155056 A1
(43) Pub. Date: Jun. 7, 2018

(54) Flight Landing Sequence of an Unmanned Aerial Vehicle into the Hand of the Operator

(71) Applicant: LR ACQUISITION, LLC, New York, NY (US)

(72) Inventors: Antoine Balaresque, Sausalito, CA (US); Henry W. Bradlow, San Francisco, CA (US)

(73) Assignee: LR Acquisition, LLC, New York, NY (US)

(21) Appl. No.: 15/588,328

(22) Filed: May 5, 2017

Related U.S. Application Data
(60) Provisional application No. 62/333,417, filed on May 9, 2016.

(51) Int. Cl. B64D 45/04; B64C 39/02; B64C 27/08; B64C 27/50; B64D 47/08

(52) U.S. Cl. CPC B64D 45/04; B64C 39/024; B64C 27/08; B64C 2201/182; B64D 47/08; B64C 2201/146; B64C 2201/108; B64C 27/50

(57) ABSTRACT

A landing sequence for the unmanned aerial vehicle (“UAV”) wherein once the landing sequence is initiated, the UAV detects the operator's hand after hovering at an operative height, then the UAV begins a dissent at an operative rate toward the operators hands reducing the lift generated by the UAV until a time where the operator's hand exerts enough pressure on the bottom of the UAV to trigger the UAV to cut all power to the motors thereby landing the UAV in the operator's hand giving the operator the ability to “catch” the UAV in their hand and not risk landing the UAV in an undesirable location.

### CROSS REFERENCE TO RELATED APPLICATION

This application claims the benefit of priority on U.S. provisional patent application U.S. 62/333,417, filed May 9, 2016, and is incorporated by reference herein.

### FIELD OF INVENTION

The presently described invention relates generally to radio-controlled/remote-controlled flight also described as an unmanned aerial vehicle (“UAV”). More specifically it related to a new and heretofore never used sequence and method for landing a remote-controlled drone into the operator's hand.

### BACKGROUND

A radio-controlled aircraft (often called RC aircraft or a UAV) is a small flying machine that is controlled remotely by an operator on the ground using a hand-held radio transmitter, The transmitter communicates with a receiver within the craft that sends signals to servomechanisms (servos) which move the control surfaces based on the position of joysticks on the transmitter. The control surfaces, in turn, affect the orientation of the plane. Flying RC aircraft as a hobby grew substantially from the 2000s with improvements in the cost, weight, performance and capabilities of motors, batteries and electronics. A wide variety of models and styles is available. UAVs or “drones” are a subset of RC aircraft that typically have a cameral or other live or recorded imaging device that allows for the user to “see” from the perspective of the drone through a receiver, including the user's smartphone.

Scientific, government and military organizations are also using RC aircraft, including drones and UAVs, for experiments, gathering weather readings, aerodynamic modeling and testing, and even using them as drones or spy planes.

### SUMMARY

The presently described invention generally relates to the landing sequence of a UAV. The present invention overcomes the drawbacks of known landing sequences by providing the user with the ability to “catch” the UAV in their hand and not risk landing the UAV in an undesirable location.

Landing after a flight is required for all consumer UAVs below 4 kilograms (including quadcopters, helicopters, and other consumer flying devices). A problem exists where there may not be a suitable landing location for the aircraft. This is often caused by a prevalence of uneven terrain, mud/water, and tall grass/shrubbery. By allowing a UAV to land in the operator's hand, the pilot can safely descent and finish a flight in any location accessible by the operator.

Once a landing sequence has been passed to the UAV, the UAV will begin a slow descent toward the ground near the flight operator. Lift being generated by the UAV will terminate once the UAV has received input that the operator's hand is in contact with the bottom of the UAV.

These and other embodiments, features, aspects, and advantages of the invention will become better understood with regard to the following description, appended claims and accompanying drawings.

### BRIEF DESCRIPTION OF THE DRAWINGS

The foregoing aspects and the attendant advantages of the present invention will become more readily appreciated by reference to the following detailed description, when taken in conjunction with the accompanying drawings, wherein:

FIG. 1 illustrates the Controller [100];

FIG. 2 is a diagram of the specific controls of the Controller [100], including the command input [101], User Input Decoder [102], Wireless Communication Transmitter [103], Barometer (or other altitude calculator) [104] and GPS [105];

FIG. 3 illustrates a side view of the Lily UAV [200];

FIG. 4 illustrates an opposing side view of the Lily UAV [200];

FIG. 5 illustrates a ¾ top view of the Lily UAV [200];

FIG. 6 is a diagram of the specific controls of the Lily UAV [200], including the Wireless Communication Receiver [201], Central Processing Unit [202], Barometer (or other altitude calculator) [203], Motor Controller [204], Motors [205], Lift Generating Mechanism [206], GPS [207], Downward Facing Image Sensor [208] and Accelerometer [209].

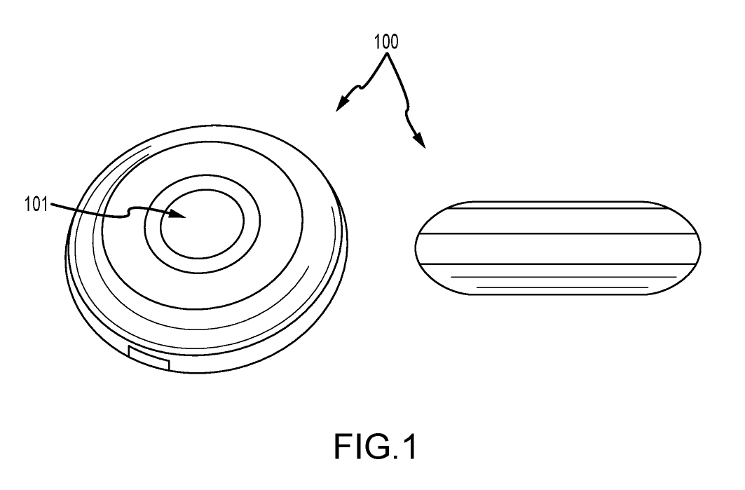

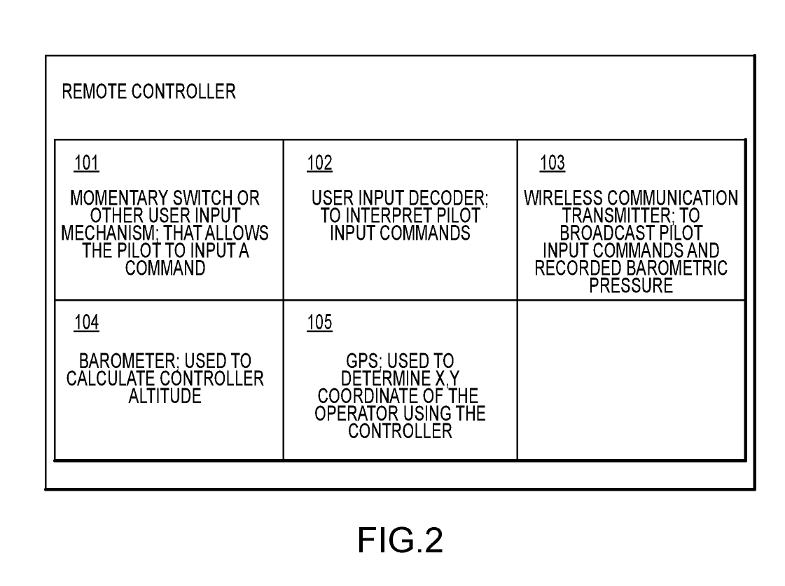

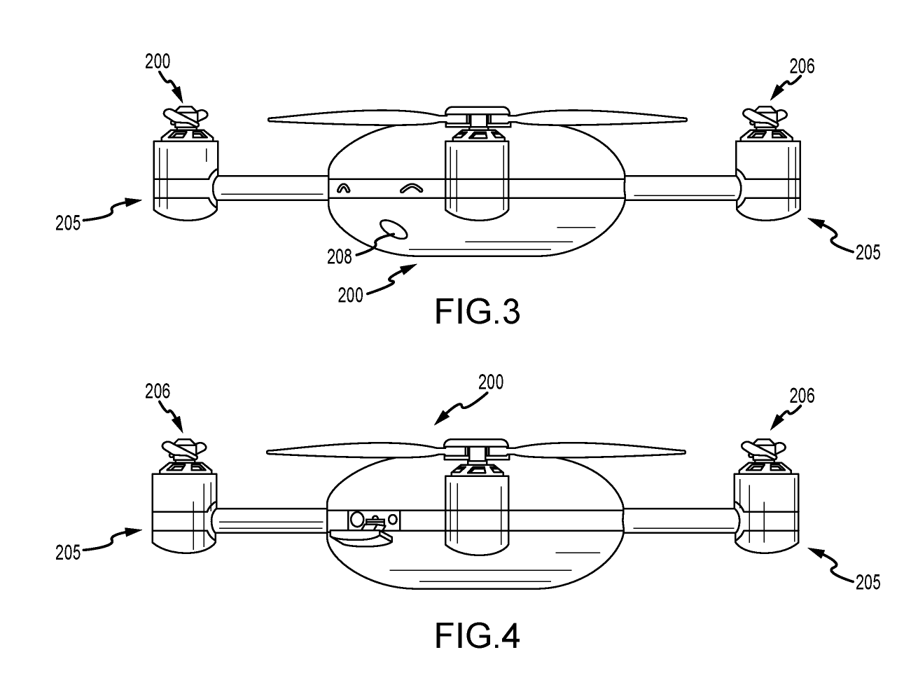

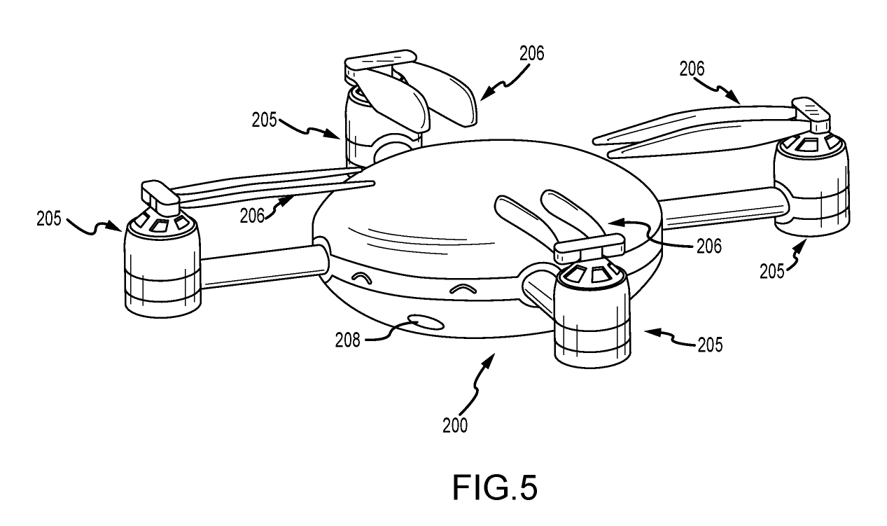

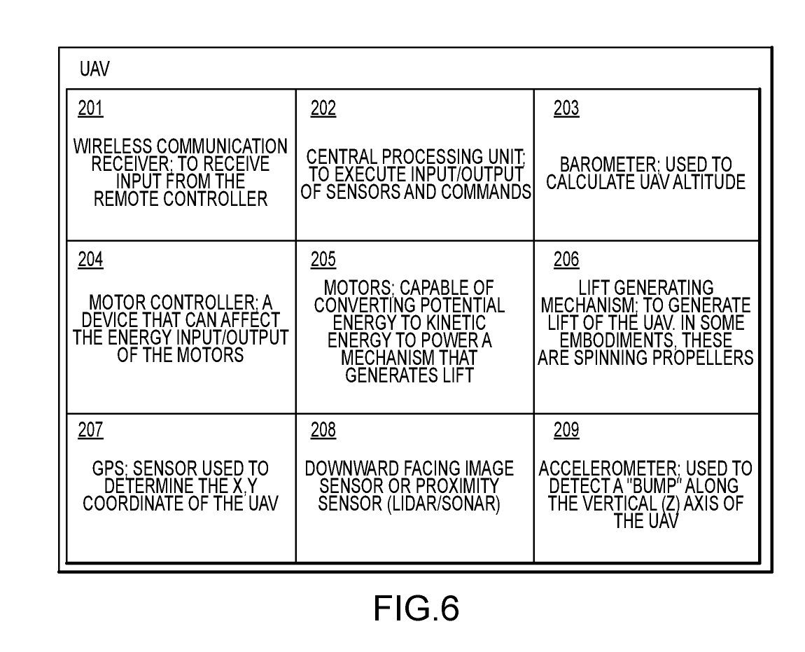

Reference symbols or names are used in the Figures to indicate certain components, aspects or features shown therein. Reference symbols common to more than one Figure indicate like components, aspects or features shown therein.

### DETAILED DESCRIPTION

The presently described invention generally relates to the landing sequence of a UAV. The present invention overcomes the drawbacks of known landing sequences by providing the user with the ability to “catch” the UAV in their hand and not risk landing the UAV in an undesirable location.

Various aspects of specific embodiments are disclosed in the following description, related drawings and table. Alternate embodiments may be devised without departing from the sprit or the scope of the present disclosure. Additionally, well-known elements of exemplary embodiments will not be described in detail or will be omitted so as not to obscure relevant details. Further, to facilitate an understanding of the description, a discussion of several terms used herein follows.

The word “exemplary” is used herein to mean “serving as an example, instance or illustration.” Any embodiment described herein as “exemplary” is not necessarily to be construed as preferred or advantageous over other embodiments. Likewise, the term “embodiments” is not exhaustive and does not require that all embodiments include the discussed feature, advantage or mode of operation.

Landing after a flight is required for all consumer UAVs below 4 kilograms (including quadcopters, helicopters, and other consumer flying devices). A problem exists where there may not be a suitable landing location for the aircraft. This is often caused by a prevalence of uneven terrain, mud/water, and tall grass/shrubbery. By allowing a UAV to land in the operator's hand, the pilot can safely descent and finish a flight in any location accessible by the operator.

Once a landing sequence has been passed to the Lily UAV, the Lily UAV will begin a slow descent toward the ground near the flight operator. Lift being generated by the Lily UAV will terminate once the Lily UAV has received input that the operator's hand is in contact with the bottom of the Lily UAV.

The Lily UAV System is comprised of both a handheld controller device (“Controller”) [100] and a flying camera unit contained in an unmanned aerial vehicle (“Lily UAV”) [200].

The Lily UAV [200] has an operative amount of sensors and controllers to allow for detection of the altitude of the Controller in conjunction with the Lily UAV or the altitude of solely the Lily UAV, wireless communication between the Controller [100] and Lily UAV [200], decoding in processing of commands, detection of an object, detection and control of the rate of assent and descent and lift generating mechanisms.

In order to properly perform the landing sequence in the operator's hand [300], the operator must have a human-like hand and have typical human-like motor control that would allow the operator to raise their hand, form an open, upward facing palm and swing their arm upward to catch the Lily UAV [200] in their open palm [301].

The landing sequence that is the subject of this patent shall include these steps:
a. The operator initiates the landing sequence for the Lily UAV [200] by operation of a command input [101] on the Controller [100];
b. The Controller [100] interprets the specific command [102] as a landing sequence;
c. The Controller [100] broadcasts the command to the Lily UAV via Wireless Communications Transmitter [103];
d. In addition to the command, the Controller [100] broadcasts barometric pressure [104] at the altitude of the Controller [100];
e. The Controller [100] will continue to broadcast barometric pressure readings at least one time per second (1 Hz) until a landing sequence has been completed or the land sequence is aborted;
f. The Lily UAV [200] receives an input signal through a Wireless Communication Receiver [201] from the Controller [100];
g. The Lily UAV [200] Central Processing Unit [202] then interprets the input command to proceed with the landing sequence;
h. The Lily UAV's [200] onboard barometer calculates the Lily UAV's [200] altitude [203];
i. The Central Processing Unit [202] on the Lily UAV [200] determines altitude variance between Lily UAV [200] and the Controller [100] by calculating variance in barometric pressures;
j. The Central Processing Unit [202] commands the control mechanisms [204, 205, 206, 207] to command flight of the Lily UAV [200] to the location of the Controller [100] based on ground position as calculated by the Controller's [100] GPS [105];
k. The landing sequence is initiated by the Central Processing Unit [202] and the control mechanisms [204, 205, 206, 207] reduce the available lift to the Lily UAV [200] such that the Lily UAV [200] then descends to an operative altitude approximately 4 meters above the altitude of the Controller [100] (z coordinate);
l. The Lily UAV [200] attempts to hover in a static position via the Motor Controller [204] which affects the energy input/output of the Motors [205] that are the mechanisms which convert potential energy to kinetic energy to power the Lily UAV [200] through :Lift Generating Mechanisms [206], which in some embodiments are spinning propellers;
m. In this hovering position, the lift generated by the Lily UAV [200] shall exactly counteract the gravitational force being exerted on the Lily UAV [200] so as to allow it to remain still via the Lift Generating Mechanisms [206];
n. The Downward Facing Image Sensor [208] is enabled to detect when an object, such as the operator's hand [300], is in contact with the bottom of the Lily UAV [200];
o. The Downward Facing Image Sensor [208] reading is obtained at least once per second (1 Hz);
p. The Central Processing Unit [202] enables the Accelerometer [209] to identify if the vertical (z) axis descent of the craft is interrupted with a measurement affecting vertical acceleration is detected counteracting the descent of the Lily UAV [200];
q. The Accelerometer reading shall be obtained at least once per second (1 Hz);
r. The Lily UAV [200] shall then reduce lift resulting in a rate of descent toward the elevation of the Controller [100] at an operative velocity not to exceed 0.5 meters/second by having the Motor Controller [204] manipulate the motors [205] and lift generating mechanisms [206];
s. The downward landing trajectory of the Lily UAV [200] along with the upward trajectory of the operator's hand [300] shall impart a measurable impact along the vertical axis of the Lily UAV [200] detected by the accelerometer [208] the force of which is generated when the operator's hand [300] and bottom of the Lily UAV [200] make contact;
t. This impact in the vertical axis on the bottom of the Lily UAV detected by the Accelerometer [208] as the operator's hand [300] “bumps” the bottom of the Lily UAV [200] it exerts an operative amount of pressure to trigger the shut-off sequence for the Lily UAV [200] including termination of power to the Motor Controller [204] and. Motors [205] terminating the lift in the Lift Generating Mechanisms [206];
u. If the Lily UAV [200] does not use their hand to “bump” the bottom of the Lily UAV [200], the Lily UAV [200] shall continue its descent until it comes in contact with the ground or another object and the object exerts an operative amount of pressure to trigger the shut-off sequence for the Lily UAV [200] including termination of power to the Motor Controller [204] and Motors [205] and terminating the lift in the Lift Generating Mechanisms [206].

In the preferred embodiment, variances in air pressure are measured by the barometer on the Controller [100] and a separate barometer on the Lily UAV [200] which measurements are then used to calculate the altitude variance between the Controller [100] and Lily UAV [200].

In a second embodiment, the Lily UAV [200] uses sonar to calculate the difference in altitude between the Lily UAV [200] and the Controller [100].

In a third embodiment, the Lily UAV [200] uses radar to calculate the difference in altitude between the Lily UAV [200] and the Controller [100].

In another embodiment, the Lily UAV [200] uses LIDAR to calculate the difference in altitude between the Lily UAV [200] and the Controller [100].

In conjunction with the various embodiments above for the altitude detector, the Downward Facing Imaging Sensor [208] in one embodiment will be computer-vision based as described in the sequence above.

In conjunction with the various embodiments for the altitude detector above, in another embodiment the Downward. Facing Imaging Sensor [208] in one embodiment will be radar based.

In conjunction with the various embodiments for the altitude detector above, in another embodiment the Downward Facing Imaging Sensor [208] in one embodiment will be LIDAR based.

In conjunction with the various embodiments for the altitude detector above, in another embodiment the Downward Facing Imaging Sensor [208] in one embodiment will be sonar based.

In conjunction with the various embodiments for the altitude detector and Downward. imaging Sensor above, in the preferred embodiment the Lift Generating Mechanism [206] will be propellers controlled by Motors [205] and a Motor Controller [204].

In conjunction with the various embodiments for the altitude detector and Downward Imaging Sensor above, in another embodiment the Lift Generating Mechanisms [206] will be rockets controlled by a Motor Controller [204].

In conjunction with the various embodiments for the altitude detector, Downward. imaging Sensor and lift generating mechanics above, in the preferred embodiment, the Lily UAV [200] will descend to an operative altitude approximately 4 meters above the Controller [100] and hover before it begins the last stage of its operator hand [300] detection and the remainder of its landing sequence.

In conjunction with the various embodiments for the altitude detector, Downward Imaging Sensor and lift generating mechanics above, in another embodiment, the Lily UAV [200] will descend directly toward the Controller [100] the operator's hand [300] without hovering.

In conjunction with the various embodiments for the altitude detector, Downward Imaging Sensor, lift generating mechanics and hovering option above, in the preferred embodiment, if the Lily UAV [200] does not use their hand to “bump” the bottom of the Lily UAV [200], the Lily UAV [200] shall continue its descent until it comes in contact with the ground or another object and the object exerts an operative amount of pressure to trigger the shut-off sequence for the Lily UAV [200] including termination of power to the Motor Controller [204] and Motors [205] and terminating the lift in the Lift Generating Mechanisms [206].

In conjunction with the various embodiments for the altitude detector, Downward imaging Sensor, lift generating mechanics and hovering option above, in another embodiment, if a “bump” has been detected before the Lily UAV [200] descends to 0.5 meters above ground level, the Lily UAV [200] shall increase lift through the lift generating mechanisms [206] by having the motor controller [204] provide additional power to the motors [205] which elevates the Lily UAV [200] to a static position that is an operative altitude above the Controller [100] until the landing sequence is initiated once again.

Although specific embodiments of the invention have been described, various modifications, alterations, alternative constructions, and equivalents are also encompassed within the scope of the invention.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

What is claimed is:

1. A method for landing an unmanned aerial vehicle in the operator's hand wherein:
an operator has a human-like hand and typical human-like motor control over that hand which would allow the operator to raise their hand, form an open, upward facing palm swing their arm upward to catch the UAV in their open palm;
the UAV System is comprised of both a handheld controller device (“Controller”) and a flying camera unit contained in an unmanned aerial vehicle (“UAV”).
the UAV has an operative amount of sensors and controllers to allow for the detection of the altitude of the Controller in conjunction with the UAV or the altitude of solely the UAV, wireless communication between the Controller and UAV, decoding in processing of commands, detection of an object, detection and control of the rate of assent and descent and lift generating mechanisms.
wherein the operator initiates the landing sequence for the UAV by operation of a command input on the Controller;
wherein the Controller interprets the specific command as a landing sequence;
wherein the Controller broadcasts the command to the UAV via Wireless Communications Transmitter;
wherein the Controller broadcasts barometric pressure at the altitude of the Controller;
wherein the Controller will continue to broadcast barometric pressure readings at least one time per second (1 Hz) until a landing sequence has been completed or the land sequence is aborted;
wherein the UAV receives an input signal through a Wireless Communication Receiver from the Controller;
wherein the UAV Central Processing Unit then interprets the input command to proceed with the landing sequence;
wherein the UAV's onboard barometer takes a pressure reading and calculates the UAV's altitude;
wherein the Central Processing Unit on the UAV determines altitude variance between UAV and the Controller by calculating variance in barometric pressures;
wherein the Central Processing Unit commands the control mechanisms to command flight of the UAV to the location of the Controller based on ground position as calculated by the Controller's GPS;
wherein the landing sequence is initiated by the Central Processing Unit and the control mechanisms reduce the available lift to the UAV such that the UAV then descends to an operative altitude above the altitude of the Controller (z coordinate);
wherein the operative altitude is 4 meters or less above the altitude of the Controller;
wherein the UAV attempts to hover in a static position via the Motor Controller which affects the energy input/output of the Motors that are the mechanisms which convert potential energy to kinetic energy to power the UAV through Lift Generating Mechanisms;
wherein the Lift Generating Mechanisms will be propellers controlled by Motors and a Motor Controller;
wherein in this hovering position, the lift generated by the UAV through Lift Generating Mechanisms shall exactly counteract the gravitational force being exerted on the UAV so as to allow it to remain still;
wherein the Downward Facing image Sensor is enabled to detect when an object, such as the operator's hand, is in contact with the bottom of the UAV;
wherein the Downward Facing Image Sensor reading is obtained at least once per second (1 Hz);
wherein Downward Facing Imaging Sensor in one embodiment will be computer-vision based;
wherein the Central Processing Unit enables the Accelerometer to identify if the vertical (z) axis descent of the craft is interrupted with a measurement affecting vertical acceleration is detected counteracting the descent of the UAV;
wherein the Accelerometer reading shall be obtained at least once per second (1 Hz);
wherein the UAV shall then reduce lift resulting in a rate of descent toward the elevation of the Controller at an operative velocity not to exceed 0.5 meters/second by having the Motor Controller manipulate the motors and lift generating mechanisms;
wherein the downward landing trajectory of the UAV along with the upward trajectory of the operator's hand shall impart a measurable impact along the vertical axis of the UAV detected by the accelerometer the force of which is generated when the operator's hand and bottom of the UAV make contact;
wherein this impact in the vertical axis on the bottom of the UAV is detected by the Accelerometer as the operator's hand “bumps” the bottom of the UAV it exerts an operative amount of pressure to trigger the shut-off sequence for the UAV including termination of power to the Motor Controller and Motors terminating the lift in the Lift Generating Mechanisms;
wherein if the UAV does not use their hand to “bump” the bottom of the UAV, the UAV shall continue its descent until it comes in contact with the ground or another object and the object exerts an operative amount of pressure to trigger the shut-off sequence for the UAV including termination of power to the Motor Controller and Motors and terminating the lift in the Lift Generating Mechanisms.

2. The method of claim 1, wherein the difference in altitude between the UAV and the Controller is detected by radar.

3. The method of claim 1, wherein Downward Facing Imaging Sensor in one embodiment will be radar based.

4. The method of claim 2, wherein Downward Facing Imaging Sensor in one embodiment will be radar based.

5. The method of claim 1, wherein the UAV will descend directly toward the Controller the operator's hand without hovering.

6. The method of claim 2, wherein the UAV will descend directly toward the Controller the operator's hand without hovering.

7. The method of claim 3, wherein the UAV will descend directly toward the Controller the operator's hand without hovering.

8. The method of claim 4, wherein the UAV will descend directly toward the Controller the operator's hand without hovering.

9. The method of claim 1, wherein during the landing sequence if a “bump” has been detected before the UAV descends to an operative height above ground level, approximately 0.5 meters, the UAV shall increase lift through the Lift Generating Mechanisms elevating the UAV to a static position that is an operative altitude above the Controller until the landing sequence is initiated once again.

10. The method of claim 2, wherein during the landing sequence if a “bump” has been detected before the UAV descends to an operative height above ground level, approximately 0.5 meters, the UAV shall increase lift through the Lift Generating Mechanisms elevating the UAV to a static position that is an operative altitude above the Controller until the landing sequence is initiated once again.

3. method of claim 3, wherein during the landing sequence if a “bump” has been detected before the UAV descends to an operative height above ground level, approximately 0.5 meters, the UAV shall increase lift through the Lift Generating Mechanisms elevating the UAV to a static position that is an operative altitude above the Controller until the landing sequence is initiated once again.

12. The method of claim 4, wherein during the landing sequence if a “bump” has been detected before the UAV descends to an operative height above ground level, approximately 0.5 meters, the UAV shall increase lift through the Lift Generating Mechanisms elevating the UAV to a static position that is an operative altitude above the Controller until the landing sequence is initiated once again.

13. The method of claim 5, wherein during the landing sequence if a “bump” has been detected before the UAV descends to an operative height above ground level, approximately 0.5 meters, the UAV shall increase lift through the Lift Generating Mechanisms elevating the UAV to a static position that is an operative altitude above the Controller until the landing sequence is initiated once again.

14. The method of claim 6, wherein during the landing sequence if a “bump” has been detected before the UAV descends to an operative height above ground level, approximately 0.5 meters, the UAV shall increase lift through the Lift Generating Mechanisms elevating the UAV to a static position that is an operative altitude above the Controller until the landing sequence is initiated once again.

15. The method of claim 7, wherein during the landing sequence if a “bump” has been detected before the UAV descends to an operative height above ground level, approximately 0.5 meters, the UAV shall increase lift through the Lift Generating Mechanisms elevating the UAV to a static position that is an operative altitude above the Controller until the landing sequence is initiated once again.

16. The method of claim 8, wherein during the landing sequence if a “bump” has been detected before the UAV descends to an operative height above ground level, approximately 0.5 meters, the UAV shall increase lift through the Lift Generating Mechanisms elevating the UAV to a static position that is an operative altitude above the Controller until the landing sequence is initiated once again.
